(19) United States
(12) Patent Application Publication
(10) Pub. No.: US 2012/0266823 A1
(43) Pub. Date: Oct. 25, 2012

(54) METHOD FOR REDUCING EMISSION OF CARBONACEOUS GASSES

(75) Inventor: Thomas Alexander North Harttung, Barrit (DK)

(73) Assignee: BLACKCARBON A/S, Barrit (DK)

(21) Appl. No.: 13/501,672

(22) PCT Filed: Oct. 12, 2010
(86) PCT No.: PCT/DK10/50261

§ 371 Date: Jul. 12, 2012

(30) Foreign Application Priority Data
Oct. 12, 2009 (DK) PA 2009 70154

(51) Int. Cl. A23K 1/175; A01K 5/00; A23K 1/18

(52) U.S. Cl. 119/51.01; 426/2; 426/648; 426/635; 426/636; 426/512

(57) ABSTRACT

The invention relates to a method for reducing the emission of methane, and possible other carbonaceous gasses being produced during processing of feed in the bowel of livestock, into the atmosphere. The method comprises feeding the livestock with feed comprising solid carbonaceous matter, the livestock digesting the feed, methane and possible other carbonaceous gasses being encapsulated within the structure of said carbonaceous matter, the livestock moving bowels with faeces, the methane and possible other carbonaceous gasses being encapsulated in the voids of the solid carbonaceous matter also after the livestock have made bowels with the faeces. The invention further relates to an animal feed composition comprising solid carbonaceous matter having voids within the structure of the matter, and to a method and an apparatus for producing such animal feed composition.

### FIELD OF THE INVENTION

The invention relates to a method for reducing the emission of methane and possible other carbonaceous gasses from livestock into the atmosphere. The invention also relates to an animal feed composition for reducing the emission of methane and possible other carbonaceous gasses from livestock into the atmosphere. Furthermore, the invention relates to a method and an apparatus for manufacturing such animal feed composition.

### BACKGROUND OF THE INVENTION

Cattle typically lose 6% of their ingested energy as eructated methane. Animal science nutrition research has focused on finding methods to reduce methane emissions because of its inefficiency not because of the role of methane in global warming. However, because methane can affect climate directly through its interaction with long-wave infrared energy and indirectly through atmospheric oxidation reactions that produce CO₂, a potent greenhouse gas, more recent attention has been given to its potential contribution to climatic change and global warming.

Eructation of methane by cattle begins approximately 4 wk after birth when solid feeds are retained in the reticulorumen. Fermentation and methane production rates rise rapidly during reticulorumen development. Estimates of yearly methane production of the typical beef and dairy cow range from 60 to 71 kg and 10 to 126 kg, respectively.

Negative environmental and health effects, such as global warming, smog, and respiratory problems in humans caused by the emission of harmful pollutants such as methane and carbon dioxide (CO₂), have resulted in countries, states, and territories throughout the world regulating the amount of emissions permitted by businesses and industries. Some scientists claim that the CO₂ emissions are causing global warming under the theory that the emissions create a greenhouse effect. The source of these and other emission pollutants can come from a myriad of industries such as industries breeding livestock and energy industries.

Various countries have agreed to reduce their CO₂ emissions under the Kyoto Protocol. The Kyoto Protocol is a protocol to the international Framework Convention on Climate Change with the objective of reducing greenhouse gases in an effort to prevent anthropogenic climate change.

As of August 2009, 189 parties have ratified the protocol. One hundred thirty seven developing countries have ratified the protocol, including Brazil, China and India, but have no obligation beyond monitoring and reporting emissions. Thirty six developed C.G. countries including the EU as a party in its own right are required to reduce greenhouse gas emissions to the levels specified for each of them in the treaty (representing over 63.7% of emissions from Annex I countries). The Kyoto Protocol provides a complex system which will allow some countries to buy emission credits from others.

The emission credits (or carbon credits) are measured in “equivalent metric tons of carbon dioxide”, the main heat-trapping gas blamed by scientists for climate change. Thus, one credit is equal to one tonne of CO₂-equivalent. This means that all other greenhouse gasses have to be converted into CO₂-equivalents.

Under the Kyoto Protocol, the Conference of the Parties decided (decision 2/CP.3) that the values of “Global Warming Potential” calculated for the IPCC Second Assessment Report are to be used for converting the various greenhouse gas emissions into comparable CO₂ equivalents when computing overall sources and sinks. GWP is a measure of how much a given mass of greenhouse gas is estimated to contribute to global warming. It is a relative scale which compares the gas in question to that of the same mass of carbon dioxide, whose GWP is by definition 1.

The Clean Development Mechanism (CDM) is an arrangement under the Kyoto Protocol allowing industrialised countries with a greenhouse gas reduction commitment (called Annex 1 countries) to invest in projects that reduce emissions in developing countries as an alternative to more expensive emission reductions in their own countries. A crucial feature of an approved CDM carbon project is that it has established that the planned reductions would not occur without the additional incentive provided by emission reductions credits, a concept known as “additionality”.

Having a substance containing the ionic constituents of the gas is known, such as liquid manure or a slurry of partly liquids, partly solid manure. Often methane and other gasses are collected in closed tanks, or the manure is added a catalyser or the like to eliminate formation of methane and/or other carbonaceous gas by electrochemical ion bonding.

Forming carbonaceous solid matter in a pyrolytic process is also known. It is also known that the pyrolytic matter has voids so that the carbonaceous matter has a certain porosity. Often, a pyrolytic process is used for burning gasses formed during the pyrolytic process. The solid matter formed during pyrolysis may be disposed of, either by being burned for energy or by being recycled as fertilizer.

### SUMMARY OF THE INVENTION

It may be seen as an object of the present invention to provide a method, which gives a possibility to reduce the emission of methane and possible other carbonaceous gasses from livestock into the atmosphere for livestock.

The object may be obtained by a method for reducing the emission into the atmosphere of methane and possible other carbonaceous gasses being produced during processing of feed in the bowel of livestock, said method comprising feeding the livestock with feed comprising solid carbonaceous matter having voids within the structure of said carbonaceous matter, the livestock digesting the feed, methane and possible other carbonaceous gasses being encapsulated in the voids within the structure of said carbonaceous matter, the livestock moving bowels with faeces including at least part of the feed having been digested, the methane and possible other carbonaceous gasses being encapsulated in the voids of the solid carbonaceous matter also after the livestock have made bowels with the faeces.

The method according to the invention for reducing the emission into the atmosphere of methane and possible other carbonaceous gasses being produced during processing of feed in the bowel of livestock has the advantage that the methane is absorbed in a manner where only products produced on a farm may be employed in absorbing the methane. Also, the method according to the invention absorbs the methane and possible other carbonaceous gasses before the methane and possible other carbonaceous gasses are out of the one or more stomachs of the livestock.

The carbonaceous matter used as absorbent may be formed by subjecting plant material to temperatures of at the maximum 700° C. in a pyrolytic process thereby forming the carbonaceous matter having a solid structure. Utilising low pyrolyse temperature reduced energy consumption when manufacturing the carbonaceous matter.

The raw material for the pyrolysis process may be corn, straw, wood or other organic material. Using corn, straw, wood or other organic material has the advantage that the raw material for the pyrolysis process may be products produced on a farm, in forestry or at another agricultural production site

Also, the amount of carbon-dioxide produced is limited to the very lowest amount possible. Pyrolysis is a process forming a limited amount of carbon-dioxide due to the raw material not being fully burned. Also, the emission of other greenhouse gasses is also limited to the very minimum. Especially methane is about twenty times more harmful than carbon-dioxide as a pollutive greenhouse gas.

The carbonaceous matter according to the invention can function as a greenhouse gas sink, where greenhouse gas can be absorbed from the faeces of livestock. Simultaneously, the carbonaceous matter according to the invention can function as an inhibitor of methane and carbon dioxide forming micro bacteria in the faeces of livestock, thereby additionally reducing the discharge of the greenhouse gas into the atmosphere.

By the method according to the invention, the methane in the faeces is absorbed in the carbonaceous matter. The carbonaceous matter may subsequently be burned off, thereby producing carbon-dioxide as all burning will do. Alternatively, the carbonaceous matter may be used as a soil improving agent, e.g. as an enriched fertilizer not only having the fertilising benefits of the carbonaceous matter itself, but also having the fertilising advantages of the methane absorbed in the carbonaceous matter.

The method according to the invention may also be used by privates, by industrial entities and by governments to fulfill the Kyoto Protocol. The Kyoto Protocol is a ‘cap and trade’ system that imposes national caps on the emissions of greenhouse gasses. Although these caps are national-level commitments, in practice most countries will devolve their emissions targets to individual industrial entities, such as a farm with livestock.

The possible buyers of Credits may be privates and industrial entities that expect their emissions to exceed their quota. Typically, they will purchase Credits directly from another party with excess allowances, from a broker, or from an Energy Saving Company (ESCO).

Carbon Credits are tradable instruments with a transparent price and with a measurable amount for trading. The market is expected to grow substantially, with banks, brokers, funds, arbitrageurs, ESCOs and private traders eventually participating.

According to an aspect of the invention the concentration of said supplemental solid carbonaceous matter in said animal feed is from about 0.1% w/w to about 50% w/w.

According to a further aspect of the invention the solid carbonaceous matter is having voids within the structure of the matter so that said matter is having a porosity resulting in storage to volume ratio of at least 50 to 1, possibly of at least 100 to 1, even more possible 150 to 1, even further possible resulting in a storage to volume ratio above 180 to 1.

The porosity may be measured by different methods. One method is the so-called volume/density method. The method involves loading the solid carbonaceous matter into some kind of container of a known volume. Before loading the solid carbonaceous matter into the container, weigh the container to determine its empty weight. Load the solid carbonaceous matter into the container. Weigh the container with the solid carbonaceous matter. Subtract the weight of the container to determine the weight of just the solid carbonaceous matter. Now both the volume and the weight of the solid carbonaceous matter may be determined. The weight of the solid carbonaceous matter divided by the density of the solid carbonaceous matter gives the volume that the solid carbonaceous matter takes up, minus the pore volume. The pore volume is then determined by the following equation: Pore volume is equal to total volume minus material volume.

According to an aspect of the invention, the carbonaceous matter is used as a greenhouse gas sink, said greenhouse gas being produced during processing of feed in the bowel of livestock and/or during storage of livestock excrements.

In a second aspect, the invention provides an animal feed composition comprising solid carbonaceous matter having voids within the structure of the matter, wherein the concentration of said supplemental solid carbonaceous matter in said animal feed is from about 0.1% w/w to about 50% w/w.

Said animal feed composition may further be used as a medicament. The animal feed composition used as a medicament may reduce the amount of bacteria producing methane in the one or more stomachs of the livestock.

Said animal feed composition may further be used for the manufacture of a medicament. Using solid carbonaceous matter in an animal feed composition for the manufacture of a medicament results in a new medicament for livestock.

The animal feed composition might be embodied in any substance suitable for feeding to animals (particularly to ruminants) in admixture with other feedstuffs, for example in compound feeds, feed blocks, liquid feed supplements, drenches or slow-release pellets The substances may each fulfil one or more useful functions; for example, they may act as methane inhibitors, they may control rumen fermentation (which, in turn, leads to enhanced animal performance), they may act as sources of energy, they may act as preservatives for animal feedstuffs.

In a specific implementation, the invention further provides an animal feed composition wherein said carbonaceous matter is having a largest size of less than 5 mm, preferably a largest size less than 4 mm, more preferred a largest size of less than 2 mm, even more preferred a largest size of less than 1 mm, possible a largest size of less than 0.5 mm, and having a smallest size more than 0.1 mm. Selecting the size of the animal feed composition according to the above results in a biasing between the livestock's ability to eat the feed composition and the feed composition's ability to absorb methane and possible other carbonaceous gasses.

In yet another specific implementation, the invention further relates to an animal feed composition wherein the solid carbonaceous matter is being formed during a pyrolysis process of plant raw material, possibly raw material from wood such as conifer, even possibly raw material from crops such as maize, even more possibly raw material from organic waste material. Using plant raw material, possibly raw material from wood such as conifer, even possibly raw material from crops such as maize, even more possibly raw material from organic waste material has the advantage that the solid carbonaceous matter may be produced from products on a farm, in forestry or at another agricultural or industrial production site.

In another implementation, the invention relates to use of an animal feed composition as an additive in compound feeds, feed blocks, liquid feed supplements, drenches, slow release pellets and/or ensiled green fodder, hay and grain. The animal feed composition may be added to feed for livestock, either during manufacture of the livestock feed, at a site between manufacture and a livestock feeding location, or at the livestock feeding location.

In yet another implementation, the invention relates to a method for producing an animal feed, said method comprising mixing solid carbonaceous matter with animal feed, and forming the mixture into animal feed composition of a desired structure, shape and size. The solid carbonaceous matter may be mixed with animal feed, either during manufacture of the feed, at a site between manufacture and a site of feeding, or at the site of feeding the livestock with feed added the animal feed composition.

In still another implementation, the invention relates to a method for producing an animal feed, said method comprising providing animal feed, not containing solid carbonaceous matter, having nutritional matter within the animal feed at a livestock feeding location, providing solid carbonaceous matter having voids within the structure of said carbonaceous matter at the livestock feeding location, at least supplying, preferably mixing, at the livestock feeding location, the solid carbonaceous matter with the animal feed. Supplying the solid carbonaceous matter at the livestock feeding location has the advantage that at least the amount, possibly also the grain size, of the solid carbonaceous matter may be adjusted depending on which kind of livestock is fed, and depending on whether the livestock being fed are newly born, half-grown, or full-grown livestock.

An alternative or supplementary method according to the invention is a method for determining an emission credit in a greenhouse gas sink following absorption of a greenhouse gas from excrements of livestock,

a) said greenhouse gas sink comprising carbonaceous matter being formed during a pyrolysis process, said method comprising the steps of

b) measuring an amount of emission of greenhouse gas from a predefined amount of manure for a predefined period of time

c) measuring the amount of emission of greenhouse gas from a mixture of manure and predefined amount of said greenhouse gas sink,

d) said amount of manure and period of time being the same as in a)

e) establishing the amount of greenhouse gas capable of being stored in predefined amount of said greenhouse gas sink

f) quantifying the total reduction of emitted greenhouse gas per amount greenhouse gas sink, submerged in the manure, per amount of manure for a predefined period of time, and

g) quantifying the amount of emission credits per amount greenhouse gas sink.

According to an aspect of the invention, it is possible to establish, at an early stage and at a basis being possible to determine objectively, to define how many emission credits a certain amount of carbonaceous matter, when used as a greenhouse gas sink, are equivalent to.

The possible period of time, within which measuring an amount of emission of greenhouse gas from a predefined amount of manure is performed, is within the interval of 1 hour to 1 year, such as 1 hour to 3 months, such as 1 hour to 1 month, such as 6 hours to 1 year, such as 12 hours to 1 year, such as 1 week to 1 year, such as 1 month to 1 year. The choice of period of time may differ depending on different parameters individually or in combination such as: the organic waste material in question, the concentration of greenhouse gas in the organic waste material, the certainty needed or desired of the measuring being performed within the period of time and possible other parameters.

The possible amount of greenhouse gas sink is within the interval of 10 mg to 1000 metric tonnes, such as 500 mg to 1 metric tonnes, such as 1 gram to 100 kg, such as 50 gram to 10 kg, preferably the predefined amount of said greenhouse gas sink is 1 kg. The choice of amount of greenhouse gas sink may differ depending on different parameters individually or in combination such as: the organic waste material in question, the concentration of greenhouse gas in the organic waste material, the certainty needed or desired of the measuring being performed within the period of time and possible other parameters.

The possible amount of manure is within the interval of 10 mg to 1000 kg, such as 1 gram to 100 kg, such as 5 gram to 50 kg, such as 10 gram to 30 kg, preferably the predefined amount of said amount manure is 10 kg. The choice of amount of manure may differ depending on different parameters individually or in combination such as: the organic waste material in question, the concentration of greenhouse gas in the organic waste material, the certainty needed or desired of the measuring being performed within the period of time and possible other parameters.

The greenhouse gas intended for being absorbed by carbonaceous matter, when used as a greenhouse gas sink, may be a mixture of different greenhouse gases, preferably a mixture of methane and CO2, or the greenhouse gas intended for being absorbed by carbonaceous matter, when used as a greenhouse gas sink, may be one greenhouse gas only, preferably methane only.

### BRIEF DESCRIPTION OF THE DRAWINGS

The invention will hereafter be described with reference to the drawing where

FIG. 1 is a photograph showing two different kinds of carbonaceous matter.

### DETAILED DESCRIPTION OF THE INVENTION

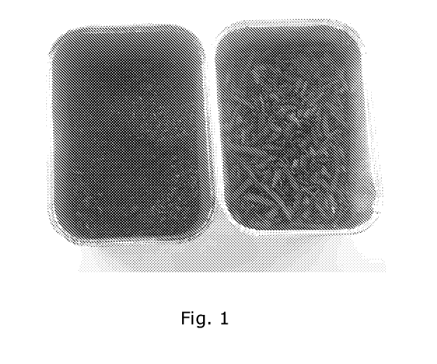

FIG. 1 shows two different sizes of solid carbonaceous matter obtained by a pyrolysis process. The raw material of the pyrolysis process is pine wood and the solid carbonaceous matter is coke having a largest size of 5 mm (to the left, called Coke1) and having a size generally larger than 5 mm (to the right, called Coke2).

An apparatus for performing the pyrolysis process is possibly an apparatus incorporating a Stirling machine as the one described in international patent application WO97/03283, the content of which is hereby incorporated by reference.

According to the Stirling machine of WO97/03283, the Stirling machine may comprise at least four, and possibly eight, twelve or any other multiple of four cylinders which are aligned in two parallel, transversely spaced rows so as to define one or more quadrangular arrangement of cylinders.

Preferably, a double-acting piston is arranged within each cylinder and dividing the cylinder into a warm and a cold cylinder chamber, the warm chamber of each cylinder being interconnected with the cold chamber of the succeeding cylinder in a succession of cylinders along the perimeter of the quadrangular arrangement.

A combustion chamber common to a group of four, eight or more cylinders may then be arranged within, above, below or adjacent to each quadrangular arrangement of cylinders, whereby heat from the combustion chamber may effectively be transferred to the warm chambers of the cylinders. Each combustion chamber may have walls defining therein closed gas spaces, the warm cylinder chamber of each cylinder of the group communicating with one end region of at least one of said gas spaces, which at the opposite end region communicates with the cold cylinder chamber of the succeeding cylinder through at least one heat regenerator and at least one cold space.

The Stirling machine may be arranged upside down with the combustion chamber for burning wood chips arranged below the cylinders and the machines being part of a domestic heating and possibly also electricity generation installation, or even being part of a combined district heating and electricity generation installation. The sizes of the Stirling machines in which the apparatus according to the invention can be embodied are not limited to any range as the principles can be applied to all sizes of such machines. A proposed size, however not limiting the possible size, of a Stirling Machine for domestic use is between 40 kW and 150kW.

1. A method for reducing the emission into the atmosphere of methane and possible other carbonaceous gasses being produced during processing of feed in the bowel of livestock, said method comprising feeding the livestock with feed comprising solid carbonaceous matter having voids within the structure of said carbonaceous matter, the livestock digesting the feed, methane and possible other carbonaceous gasses being encapsulated in the voids within the structure of said carbonaceous matter, the livestock moving bowels with faeces including at least part of the feed having been digested, the methane and possible other carbonaceous gasses being encapsulated in the voids of the solid carbonaceous matter also after the livestock have made bowels with the faeces.

2. A method according to claim 1, wherein the concentration of said supplemental solid carbonaceous matter in said animal feed is from about 0.1% w/w to about 50% w/w.

3. A method according to claim 2, wherein said solid carbonaceous matter having voids within the structure of the matter so that said matter is having a porosity resulting in storage to volume ratio of at least 50 to 1, possibly of at least 100 to 1, even more possible 150 to 1, even further possible resulting in a storage to volume ratio above 180 to 1.

4. A method according to claims 1-3, wherein the carbonaceous matter is used as a greenhouse gas sink, said greenhouse gas being produced during processing of feed in the bowel of livestock and/or during storage of livestock excrements.

5. An animal feed composition comprising solid carbonaceous matter having voids within the structure of the matter, wherein the concentration of said supplemental solid carbonaceous matter in said animal feed is from about 0.1% w/w to about 50% w/w.

6. An animal feed composition according to claim 5, wherein said carbonaceous matter is having a largest size of less than 5 mm, preferably a largest size less than 4 mm, more preferred a largest size of less than 2 mm, even more preferred a largest size of less than 1 mm, possible a largest size of less than 0.5 mm, and having a smallest size more than 0.1 mm.

7. An animal feed composition according to claim 5, wherein the solid carbonaceous matter is being formed during a pyrolysis process of plant raw material, possibly raw material from wood such as conifer, even possibly raw material from crops such as maize, even more possibly raw material from organic waste material.

8.-11. (canceled)

12. An animal feed composition according to claim 6, wherein the solid carbonaceous matter is being formed during a pyrolysis process of plant raw material, possibly raw material from wood such as conifer, even possibly raw material from crops such as maize, even more possibly raw material from organic waste material.

13. Use of an animal feed composition according to any of claim 5-7 or 12 as an additive in compound feeds, feed blocks, liquid feed supplements, drenches, slow release pellets and/or ensiled green fodder, hay and grain.

14. A method for producing an animal feed according to claim 5-7 or 12, said method comprising:
mixing solid carbonaceous matter as described in claims 5-6 with animal feed; and
forming the mixture into animal feed composition of a desired structure, shape and size.

15. A method for producing an animal feed according to claim 5-7 or 12, said method comprising:
providing animal feed, not containing solid carbonaceous matter, having nutritional matter within the animal feed at a livestock feeding location;
providing solid carbonaceous matter having voids within the structure of said carbonaceous matter at the livestock feeding location; and
at least supplying, preferably mixing, at the livestock feeding location, the solid carbonaceous matter with the animal feed.

16. An apparatus for producing an animal feed according to claim 5-7 or 12, said apparatus comprising:
a dosing unit for dosing to feed for livestock animal, at livestock feeding location; and
solid carbonaceous matter having voids within the structure of said carbonaceous matter.
